(19) United States
(12) Patent Application Publication
(10) Pub. No.: US 2006/0210033 A1
(43) Pub. Date: Sep. 21, 2006

(54) Context sensitive ring back service

(75) Inventors: Michel L.F. Grech, London (GB); Musa R. Unmehopa, Amersfoort (NL); Kumar V. V. Vemuri, Napperville, IL (US)

Correspondence Address: WILLIAMS, MORGAN & AMERSON, 10333 RICHMOND, SUITE 1100, HOUSTON, TX, 77042, US

(73) Assignee: Lucent Technologies, Inc.

(21) Appl. No.: 11/083,348

(22) Filed: Mar. 17, 2005

(51) Int. Cl. H04M 1/64

(52) U.S. Cl. 379/88.19

(57) ABSTRACT

The present invention provides a method of communicating with at least a calling party and at least a called party. The method includes receiving information indicative of an incoming call from the calling party, accessing context information associated with the called party in response to receiving the information indicative of the incoming call, and providing a ring-back tone based on the context information associated with the called party.

### BACKGROUND OF THE INVENTION

1. Field of the Invention

This invention relates generally to communication systems, and, more particularly, to telecommunication systems.

2. Description of the Related Art

Many telecommunication service providers offer custom ring-back services that permit users to select one or more audio cues to be played to calling parties as ring-back tones. For example, Lucent Technologies, Inc. offers a ring-back service called MiRingBack. When a calling party is attempting to establish a connection to a called party, the selected ring-back tone is played to the calling party in lieu of the conventional “power ringing.” Exemplary ring-back tones include songs, tunes, or other such audible cues. The playing of the ring-back tone is suspended as soon as the called party answers the phone, just as is the case with normal power ringing. The ring-back tones may be selected based on calling party identity or, in some cases the provided ring-back tone may be selected randomly (or selected by some other algorithm) from a service-subscriber selected subset of ring-back tones.

Ring-back services are being widely deployed and are seeing great interest from the end-user population, thereby bringing in new revenue to service providers. However, conventional ring-back services are intended for use as a “vanity service” and so the ring-back tone typically provides no practical benefit to the subscriber or listener of the tone.

The present invention is directed to addressing the effects of one or more of the problems set forth above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for communicating with at least a calling party and at least a called party. The method includes receiving information indicative of an incoming call from the calling party, accessing context information associated with the called party in response to receiving the information indicative of the incoming call, and providing a ring-back tone based on the context information associated with the called party.

### BRIEF DESCRIPTION OF THE DRAWINGS

The invention may be understood by reference to the following description taken in conjunction with the accompanying drawings, in which like reference numerals identify like elements, and in which:

FIG. 1 shows a telecommunications system, in accordance with the present invention;

FIG. 2 conceptually illustrates a method of providing a ring-back tone based on context information associated with a called party, in accordance with the present invention;

FIG. 3 conceptually illustrates a first exemplary scenario for providing a context sensitive ring-back tone, in accordance with the present invention; and

FIG. 4 conceptually illustrates a second exemplary scenario for providing a context sensitive ring-back tone, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

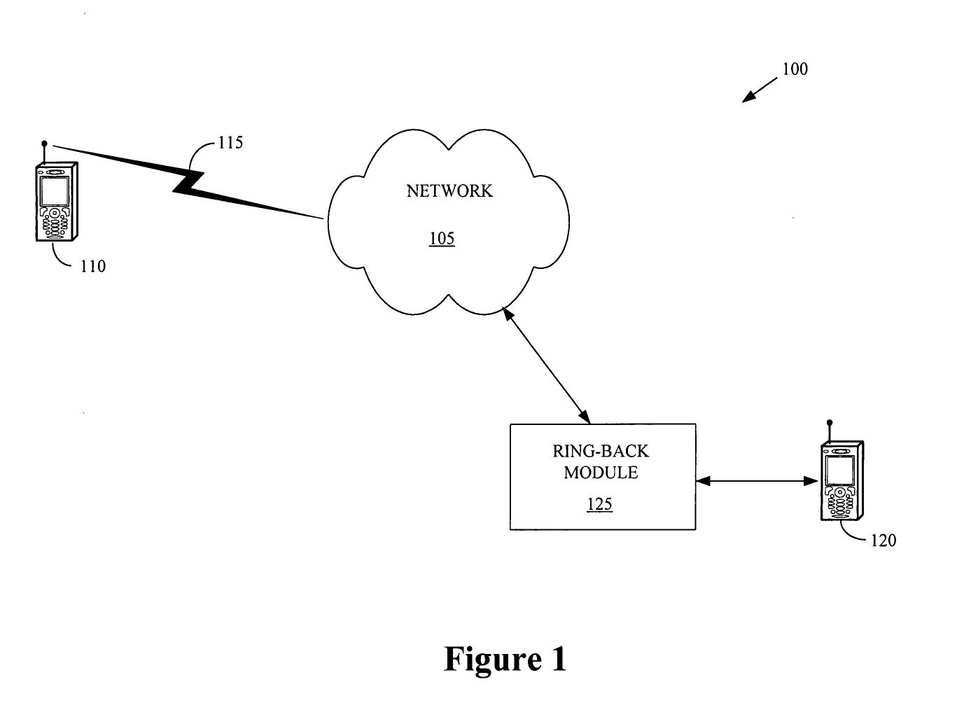

Referring now to FIG. 1, a telecommunications system 100 is shown. In the illustrated embodiment, the telecommunications system 100 includes a network 105. At least a portion of the network 105 shown in FIG. 1 is a wireless telecommunications network. In various alternative embodiments, the network 105 may operate according to one or more wireless telecommunications protocols. Exemplary wireless protocols include, but are not limited to, wide area radio telecommunications protocols such as Universal Mobile Telecommunication System (UMTS) protocols, Global System for Mobile telecommunications (GSM) protocols, Code Division Multiple Access (CDMA and/or CDMA 2000) protocols and local area telecommunications protocols such as Bluetooth protocols and one or more of the IEEE 802 protocols. However, persons of ordinary skill in the art having benefit of the present disclosure should appreciate that the present invention is not limited to any particular wired network, wireless network, or combination thereof. In alternative embodiments, the network 105 may include one or more wired networks. Exemplary wired networks include, but are not limited to, Internets, intranets, Plain Old Telephone Service (POTS) networks, Public Switched Telephone Networks (PSTN), and the like.

A mobile unit 110 is communicatively coupled to the network 105 over an air interface 115. The mobile unit 110 may also be referred to as the calling party 110 in the discussion that follows. Persons of ordinary skill in the art should appreciate that the term “calling party” may refer to either the mobile unit 110 or to a person using the mobile unit 110. As discussed above, the mobile unit 110 communicates with the network over the air interface 115 according to one or more wireless telecommunication protocols. However, persons of ordinary skill in the art having benefit of the present disclosure should appreciate that the calling party 110 does not have to be a mobile unit 110 or a user of a mobile unit 110. In alternative embodiments, the calling party 110 may be a wired telecommunication device (or a user thereof) connected to the network 105 by a wireline connection.

A mobile unit 120 is communicatively coupled to the network 105. The mobile unit 120 may also be referred to as the called party 120 in the discussion that follows. Persons of ordinary skill in the art should appreciate that the term “called party” may refer to either the mobile unit 120 or to a person using the mobile unit 120. As discussed above, the present invention is not limited to the mobile unit 120. In various alternative embodiments, the called party 120 may be a mobile unit or a wired telephone that may communicate with the network 105 according to any desirable wired and/or wireless telecommunication protocol.

The mobile unit 120 is also communicatively coupled to a ring-back module 125. Although the ring-back module 125 is depicted as a separate entity in FIG. 1, persons of ordinary skill in the art having benefit of the present disclosure should appreciate that the present invention is not limited to a standalone ring-back module 125. In alternative embodiments, portions of the ring-back module 125 may be deployed in any desirable location and/or device. For example, portions of the ring-back module 125 may be implemented in the network 105. For another example, portions of the ring-back module 125 may be implemented in the mobile unit 120. Furthermore, the ring-back module 125 may be implemented in any desirable combination of hardware and/or software.

The ring-back module 125 may receive information indicating that the calling party 110 is attempting to reach the called party 120. For example, the calling party 110 may provide a signal over the air interface 115 that is transmitted to the ring-back module 125 by the network 105. The ring-back module 125 is able to access context information associated with the called party 120, e.g. in response to the signal from the calling party 110. As used herein, the term “context information” refers to information associated with the current context of the called party 120. Context information may include information associated with the physical context of the called party 120, the temporal context of the called party 120, availability of the called party 120, the current state of mind of the called party 120, and the like. For example, the ring-back module 125 may access information indicating whether or not the called party 120 is present, temporal information such as a time of day and/or a time zone associated with the called party 120, spatial information such as a current location of the called party 120, and/or whether or not the called party 120 is available to (or wants to) receive the incoming call.

The ring-back module 125 may provide a ring-back tone based on the context information associated with the called party 120. As used herein, the term “ring-back tone” refers to an audio signal that is provided to a calling party while the calling party is waiting to be connected to a called party over the telecommunications system 100. For example, the calling party may hear a ring-back tone that includes the voice of the called party saying “I'm not available now, please call back later.” For another example, the calling party may hear a ring-back tone that includes a portion of a song or a tune. However, the term “ring-back tone,” as used herein, also refers to non-auditory signals such as text messages, photographs, images, video clips, and the like that may be provided to the calling party. For example, a ring-back tone may include a text message saying “I'm not available now, please call back later.” For another example, the ring-back tone may include a video clip of the called party saying “I'm not available now, please call back later.”

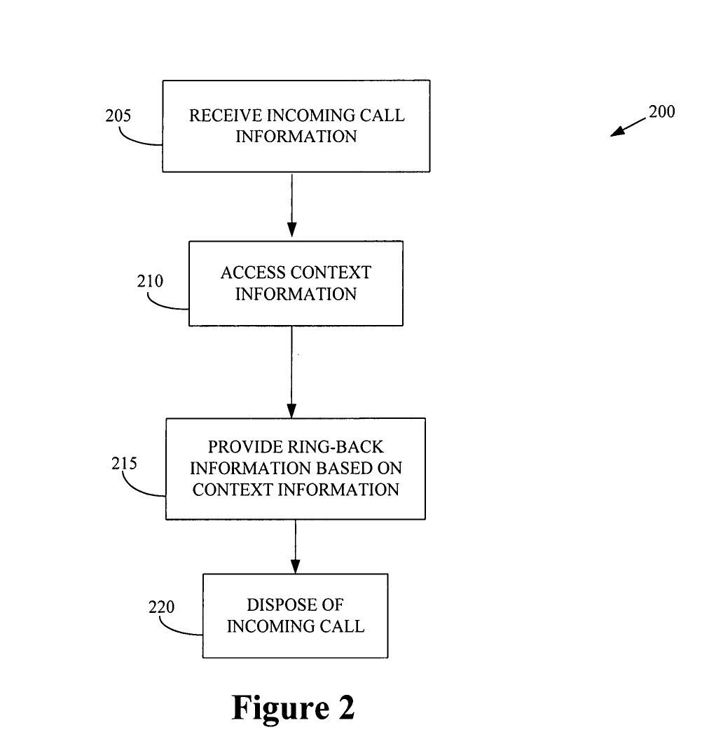

FIG. 2 conceptually illustrates an exemplary embodiment of a method 200 of providing a ring-back tone based on context information associated with a called party. In the illustrated embodiment, information indicative of an incoming call is received (at 205). For example, a calling party may provide a signal indicating that the calling party would like to establish a call with the called party. In one embodiment, the received (at 205) information may include a Call Line Identifier (CLI) that indicates the identity and/or phone number of the calling party. However, persons of ordinary skill in the art should appreciate that in some embodiments the information indicating the identity and/or phone number of the calling party, such as the Call Line Identifier (CLI), may not be available. In one alternative embodiment, the received (at 205) information may include a pass code provided by the calling party to identify the calling party or indicate a priority of the incoming call.

Context information associated with the called party is accessed (at 210) in response to receiving (at 205) the indication of the incoming call. As discussed above, context information may include presence information, temporal information, spatial information, availability information, and the like. In one embodiment, a profile associated with the called party may also be accessed (at 210). For example, the profile may include a list of rules for providing ring-back tones based on the information indicative of the calling party, such as a CLI, a pass code, and the like. The profile may also include information used to form the ring-back tone, such as a recorded message, a selected portion of a song or a tune, a photograph, an image, a video clip, and the like.

One or more ring-back tones are provided (at 215) based on the context information associated with the called party. For example, if the called party is not available because they are in a meeting that ends at about 1 p.m., and the context information indicated that it is not yet 1 p.m., a ring back tone may be provided (at 215) that says, “I am currently in a meeting, please call back after 1 p.m.” In one embodiment, information associated with the calling party and/or information in the profile associated with the called party may also be used to form the ring-back tone. For example, if the called party is a student that is currently in class (as indicated by the context information) and the calling party is identified as “Mom,” the student's profile may indicate that the provided (at 215) ring-back tone should include a voice message saying, “Hi Mom, I am in class right now, please call back later.”

In one embodiment, the incoming call may then be disposed (at 220). Disposing (at 220) of the incoming call may include disconnecting the incoming call after a timer has expired, redirecting the incoming call to a voicemail system after the timer has expired, or connecting the calling party to the called party. For example, the calling party may provide a pass code indicating that the incoming call has a very high priority, in which case the incoming call may be connected to the called party. Disposing (at 220) the incoming call may be done based upon the context information, information associated with the calling party, and/or a profile associated with the called party.

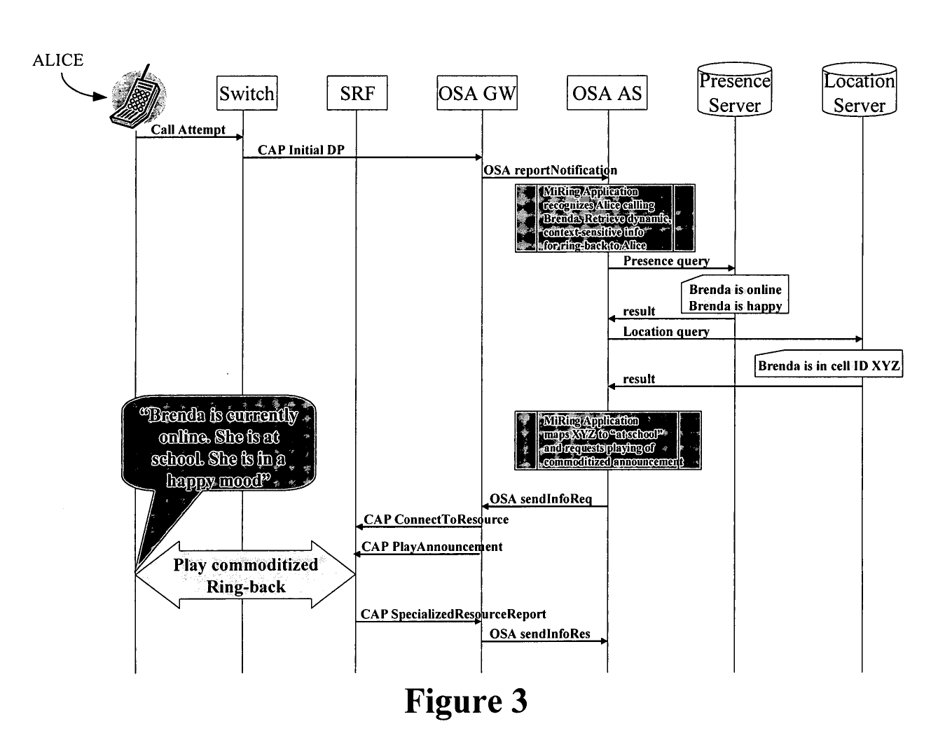

FIG. 3 conceptually illustrates a first exemplary scenario for providing a context sensitive ring-back tone. Persons of ordinary skill in the art should appreciate that the first exemplary scenario shown in FIG. 3 is intended to illustrate operation of the present invention in a particular context, but is not intended to limit the present invention. In the illustrated embodiment, a user named Alice (indicated by the mobile phone shown in FIG. 3) may want to know where her teenager daughter Brenda is, if Brenda is unable to answer her phone. Thus, Brenda may provide a context sensitive ring-back tone (e.g. using a modified version of a MiRingBack service) to Alice. For example, Brenda may configure her profile so that her location and/or presence information may be accessible to Alice when Alice attempts to call Brenda. Alternatively, Alice may be able to configure Brenda's profile so the location and presence information of her daughter's mobile is accessible to her whenever she calls.

Alice calls Brenda (Call Attempt) and instead of hearing power ringing, Alice hears a ring-back tone including an announcement saying, “Brenda is currently online. She is at school. She is in a happy mood.” The called party's presence information (“online”) and specified mood (“happy”) may be extracted from a presence server database, and her location may be queried from a network server like a GMLC (Gateway Mobile Location Center) or MPC (Mobile Positioning Center), transcoded into a descriptive location using pre-configured geographical zones (for instance, cell ID XYZ or a certain latitude-longitude pair may be translated into the descriptive location “at school”), and used to form the played announcement.

The OSA/Parlay standards bodies have developed a number of service capability features enabling third-party applications easy access to network presence, location, and terminal status information, and these technologies can be very effectively employed to support enhanced flows such as that described above. A detailed sequence diagram for carrying out the scenario described above according to the OSA/Parlay standards is depicted in FIG. 3. In this scenario, Intelligent Network triggers are armed in the network. When Alice calls Brenda (Call Attempt), this event may be detected by a switch (Switch) in the network and the armed trigger results in a CAP Initial DP sent to the OSA Gateway (OSA GW). At the OSA Gateway, the receipt of the CAP Initial DP may result in the method invocation “reportNotification” towards the OSA Application Server (OSA AS). In this scenario, the dynamic, context-sensitive ring-back application is running at the OSA Application Server (OSA AS). The OSA AS may perform a Presence query and a Location query to obtain the context-sensitive information that may be used to commoditize the ring-back tone to Alice. In this scenario, the location information is returned in the form of a cell ID (or lat/long/alt co-ordinates). Alice has pre-configured this specific cell ID XYZ to be transcoded to the descriptive location “at school”. Once all the context-sensitive information has been retrieved by the ring-back application at the OSA AS, the OSA AS will request an announcement to be played, using the “sendlnfoReq” OSA method invocation.

The OSA/Parlay network may also take other actions. For example, if Brenda did not answer, e.g. a NoAnswer timer expired in the network, Alice's call could be diverted to a voice mailbox where she could leave a message as usual. For another example, if Charlie, Brenda's friend, were to call her, he would still hear either the traditional “power-ringing” tone, or a pre-selected musical ring-back tone, but could be denied her location or presence information if his calling party number were not authorized to receive the same. In some embodiments, either the called party or the calling party (e.g. a parent) may be able to modify the privileges for ring-back access to terminal location, status or other information via a convenient Web, IVR, or other suitable interface. Note that in either case, the cues are not limited to audible media only, but could just as easily employ visual media as well, especially so if, for example 3G324M-capable or otherwise enhanced terminals were in use in these advanced call flows.

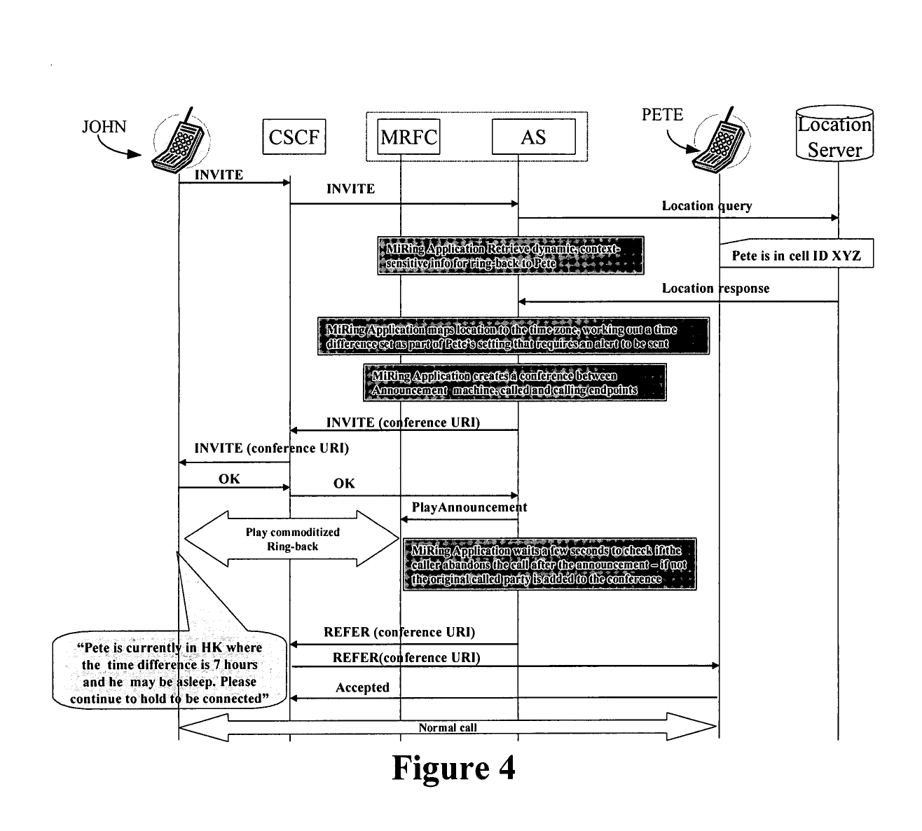

FIG. 4 conceptually illustrates a second exemplary scenario for providing a context sensitive ring-back tone. Persons of ordinary skill in the art should appreciate that the second exemplary scenario shown in FIG. 4 is intended to illustrate operation of the present invention in a particular context, but is not intended to limit the present invention. In the illustrated embodiment, Pete is a regular traveler wishes to inform callers (such as John) that he may be in a significantly different time zone than the caller. He sets up his profile so that his location information is checked for incoming calls, but the information is used to determine the time zone of Pete, as opposed to making the location information available. In the illustrated scenario, John calls Pete, and instead of hearing power ringing, John hears an announcement saying, “Pete is currently traveling and he is 4 hours ahead of his normal time zone. You may wish to consider calling at a more appropriate time however continue to hold if you still wish to be connected”. The time zone information is extracted from the location information, which may be queried from a network server such as a GMLC or MPC, transcoded to map to the time zone of the location.

Parlay/OSA standards may be utilized, as may several other alternative technical realizations. The exemplary scenario illustrated in FIG. 2 utilizes the IETF's SIP (Session Initiation Protocol) based IP Multimedia Subsystem (IMS) as defined in 3GPP and 3GPP2. In this case, John initiates a call to Pete through the INVITE message which is forwarded to the application server (AS). For example, a context-sensitive ring-back application (e.g. a modified version of MiRingBack) may be running on the AS, which is invoked by the incoming call request, based on Pete's session settings. The context-sensitive ring-back application issues a location query to determine Pete's location and/or time zone. This can be easily achieved through any desirable geo-coding capability. In some embodiments, John's location could be queried and the ring-back application could also determine the total time zone difference between the two callers.

The context-sensitive ring-back application establishes a conference between the announcement system (in this case the MRFC) and the calling endpoint (i.e. John) and once John is connected, the application instructs the MRCF to play the announcement, which indicates the time difference from Pete's normal time zone. Several different mechanisms can be used (e.g. text to speech, Voice XML) to realize this. During the time the announcement is being played, the application waits a few seconds before starting to invite Pete to the conference, allowing time for John to hang up if he does not wish to disturb Pete. If John abandons his call, the application will release the conference resources. If John considers it important enough to continue with the call, the application will invite Pete to the conference call, e.g. using a REFER method. Once Pete is joined in the conference call, the call can continue. It should be noted that FIG. 2 is illustrative of the SIP message flows and for convenience some intermediate messages for session establishment have been deliberately omitted for the sake of clarity. Persons of ordinary skill in the art should appreciate that various other mechanisms may alternatively be utilized to realize this service scenario in different network contexts (e.g. CAMEL or IN circuit switched, IMS, H.323 . . . etc).

One or more of the techniques described above may have one or more advantages over conventional practice. For example, a context sensitive ring-back service may permit a subscriber (e.g. a calling and/or called party) to define ring-back tones that calling parties will hear when they call, instead of normal power ringing. As discussed in detail above, the association of ring-back tone to a calling party can be done based on any desirable criteria, such as a time of day, a special day, individual caller identification, groups of calling parties defined by the subscriber, and the like. The ring-back service may also include a presence service and/or a call routing service to provide a single easy-to-manage service to a mobile end user, and hence create a dynamic, context-sensitive ring-back service.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of communicating with at least a calling party and at least a called party, comprising:
receiving information indicative of an incoming call from the calling party;
accessing context information associated with the called party in response to receiving the information indicative of the incoming call; and
providing a ring-back tone based on the context information associated with the called party.

2. The method of claim 1, wherein receiving information indicative of the incoming call comprises receiving information indicative of the calling party.

3. The method of claim 2, wherein receiving information indicative of the calling party comprises receiving at least one of a Call Line Identifier and a pass code.

4. The method of claim 2, wherein providing the ring-back tone comprises providing the ring-back tone based on the information indicative of the calling party.

5. The method of claim 1, wherein accessing the context information comprises accessing at least one of presence information, temporal information, spatial information, and availability.

6. The method of claim 1, wherein providing the ring-back tone comprises providing at least one of a portion of a song, a tune, a location, a presence status, a text message, a photograph, an image, and a video clip.

7. The method of claim 1, comprising accessing a profile associated with the called party.

8. The method of claim 7, wherein accessing the profile comprises accessing at least one predetermined ring-back tone based on the profile.

9. The method of claim 8, wherein accessing said at least one predetermined ring-back tone comprises selecting at least one predetermined ring-back tone profile based upon information indicative of the calling party.

10. The method of claim 1, comprising disposing of the incoming call.

11. The method of claim 10, wherein disposing of the incoming call comprises at least one of disconnecting the incoming call, directing the incoming call to a voice mail box, and connecting in the incoming call to the called party.

12. The method of claim 10, wherein disposing of the incoming call comprises disposing of the incoming call in response to expiration of a timer.

13. A method of communicating with at least a calling party and at least a called party, comprising:
providing information indicative of an outgoing call from the calling party; and
receiving a ring-back tone based on context information associated with the called party.
